(19) United States
(12) Patent Application Publication
(10) Pub. No.: US 2023/0311031 A1
(43) Pub. Date: Oct. 5, 2023

(54) Seesaw-type feeding device for collecting solid suspended materials

(71) Applicant: Dalian University of Technology, Panjin City (CN)

(72) Inventors: Kui You, Panjin (CN); Yihe Zhang, Panjin (CN); Jingkang Xu, Panjin (CN); Pengfei Yi, Panjin (CN); Meng Li, Panjin (CN); Xinghua Li, Panjin (CN); Chuanye Zhang, Panjin (CN); Caihua Ma, Panjin (CN); Weiwei Ma, Panjin (CN); Yiwen Zhang, Panjin (CN); Fangxin Han, Panjin (CN); Can You, Panjin (CN)

(21) Appl. No.: 18/207,634

(22) Filed: Jun. 8, 2023

(30) Foreign Application Priority Data
Jun. 8, 2022 (CN) 202210642918.0

(51) Int. Cl. B01D 33/29; B01D 33/72; B01D 33/80; C02F 1/40

(52) U.S. Cl. CPC B01D 33/29; B01D 33/72; B01D 33/802; C02F 1/40

(57) ABSTRACT

A seesaw-type feeding device for collecting solid materials suspended in a flow field includes a suspension assembly, a material collection assembly, a joint hinge, two anti-collision blocks and an escapement shaking assembly, wherein the latter three of which are located between the suspension assembly and the material collection assembly. The suspension assembly includes a V-shaped floating body and at least three fixed bottom anchors. The material collection assembly includes a collection pocket net, a material container, a delivery part, and an annular water discharging screen mesh. The escapement shaking assembly is located behind the V-shaped floating body and faces the material collection assembly. The material collection assembly is able to shake relatively to the fluid in the flow field, and the escapement shaking assembly drives the material collection assembly to shake.

### CROSS REFERENCE OF RELATED APPLICATION

The present invention claims priority under 35 U.S.C. 119(a-d) to CN 202210642918.0, filed Jun. 08, 2022.

### BACKGROUND OF THE PRESENT INVENTION

### Field of Invention

The present invention relates to the engineering equipment and technical field of fluid machinery, and more particularly to a seesaw-type feeding device for collecting suspended solid materials.

### Description of Related Arts

The pocket net with tail pocket is usually used for processing solid materials suspended in the flow field. The more common is the fixed collection pocket net, which can be set reasonably according to flow field conditions, so as to achieve the purpose of collecting suspended solid materials.

However, the above fixed collection pocket net has some shortcomings in the process of using as follows.
(1) The suspended solid materials in the flow field are easy to be adhered to the net body of the collection pocket net, and gradually accumulate layer by layer with the increase of use time. In addition, a variety of adhesive fouling organisms will be produced, causing the collection pocket net to be overwhelmed and lose the proper collection effect until the collection pocket net completely collapses.
(2) Because the density of suspended solid materials is unstable, when the density of suspended solid materials increases, the suspended solid materials are deposited in the lower part of the collection pocket net; when the density of suspended solid materials becomes smaller, the suspended solid materials float and accumulate in the upper part of the collection pocket net, and are difficult to automatically reach the tail pocket of the collection pocket net, so that even if the solid material treatment device is added at the tail pocket of the collection pocket net, the defect that the suspended solid materials are adhered to the net body of the collection pocket net is unable to be overcome.

### SUMMARY OF THE PRESENT INVENTION

Based on the above deficiencies, aiming at the problem that the suspended solid materials are easily adhered to the net body of the collection pocket net, affecting the effect of solid material collection in the flow field, it is necessary to provide a seesaw-type feeding device for collecting suspended solid materials.

A seesaw-type feeding device, which is configured to collect solid materials suspended in a flow field, comprises:
a suspension assembly, which comprises a V-shaped floating body floating in an upper interface of the flow field, and at least three fixed bottom anchors which are set on the V-shaped floating body;
a material collection assembly located below the suspension assembly, which comprises a collection pocket net, a material container located at one side of the collection pocket net, a delivery part located between the collection pocket net and the material container, and an annular water discharging screen mesh located between the delivery part and the material container;
a joint hinge located between the suspension assembly and material collection assembly; and
an escapement shaking assembly which is located behind the V-shaped floating body and faces the material collection assembly, wherein:
   the material collection assembly is able to shake relatively to fluid in the flow field, and the escapement shaking assembly drives the material collection assembly to shake;
   the escapement shaking assembly comprises a cam and a plectrum, wherein the plectrum is fixed on the material container, the cam is installed on the V-shaped floating body under an action of a support piece, and a drive shaft drives the cam to rotate.

The above feeding device, having a seesaw-type structure, comprises the material collection assembly. The material collection assembly shakes up and down at a certain frequency for driving the solid materials adhered to the net body to fall off, and the fall-off solid materials automatically gather towards the collection area at a tail part under the action of flow field, which effectively solves the problem that the suspended solid materials are easily adhered to the net body, so that the collection effect of suspended solid materials is ensured.

A tension mooring anchor chain is fixedly connected between each of the fixed bottom anchors and the V-shaped floating body, and a connection assembly is fixed on the V-shaped floating body

An inner surface of the delivery part having a conical structure is smooth and curved, a first end of the delivery part is connected with a tail pocket end of the collection pocket net, and a diameter of a cross section of the first end of the delivery part is larger than that of a second end of the delivery part.

An outlet end of the annular water discharging screen mesh is fixed at an opening of the material container, and a second end of the delivery part is connected with an inlet end of the annular water discharging screen mesh.

The joint hinge is fixed at a tip of the V-shaped floating body, and the material collection assembly is wholly connected with the joint hinge and is able to freely rotate in a seesaw manner.

The feeding device further comprises two anti-collision blocks for adjusting a relative position between the material collection assembly and the suspension assembly.

One of the two anti-collision blocks is fixed at a position of the V-shaped floating body facing the delivery part, and another of the anti-collision blocks is fixed at a position of the delivery part facing the V-shaped floating body.

The material collection assembly has three states: in the first state, the escapement shaking assembly does not work, the material collection assembly naturally upwardly inclines from the material container to the collection pocket net; in the second state, the escapement shaking assembly works, the material collection assembly inclines downwards to a predetermined position from the material container to the collection pocket net; in the third state, the escapement shaking assembly stops working, the material collection assembly is restored to a natural upward inclined state under an action of dead weight; the material collection assembly repeats the first, second and third states in sequence, so that the material collection assembly shakes up and down.

Compared with the prior art, the present invention has some beneficial effects as follows.

The feeding device has a seesaw-type structure. Through the shaking of the material collection assembly, the solid materials are able to continuously fall off from the net body of the collection pocket net 3. Under the action of the flow field, the solid materials gradually automatically gather to the collection area, so that the suspended solid materials in the flow field are not adhered to the net body of the collection pocket net 3, thus the defects of adhesion and fouling during solid material collection in the flow field are overcome. In practical application, the suspended solid materials in the flow field are able to be collected and processed smoothly, and the collection effect is remarkable, which reduces the cleaning and maintenance frequency of the net body, reduces the maintenance cost, improves the work efficiency, so that the promotion prospect is excellent.

### BRIEF DESCRIPTION OF THE DRAWINGS

FIG. 1 shows the placement of two seesaw-type feeding devices for collecting suspended solid materials provided by the present invention.

FIG. 2 is a structurally schematic diagram of a V-shaped floating body of a seesaw-type feeding device shown in FIG. 1.

FIG. 3 is a schematic diagram of the seesaw-type feeding device for collecting suspended solid materials provided by the present invention.

FIG. 4 is a partial exploded view of FIG. 3.

FIG. 5 is a schematic diagram of the seesaw-type feeding device in the first state provided by the present invention.

FIG. 6 is a schematic diagram of the seesaw-type feeding device in the second state provided by the present invention.

FIG. 7 is a schematic diagram of the seesaw-type feeding device in the third state provided by the present invention.

In the drawings, 1: V-shaped floating body; 2: fixed bottom anchor; 3: collection pocket net; 4: material container; 5: delivery part; 6: annular water discharging screen mesh; 7: joint hinge; 8: anti-collision block; 9: escapement shaking assembly.

### DETAILED DESCRIPTION OF THE PREFERRED EMBODIMENT

The present invention will be further described in detail with reference to accompanying drawings as follows.

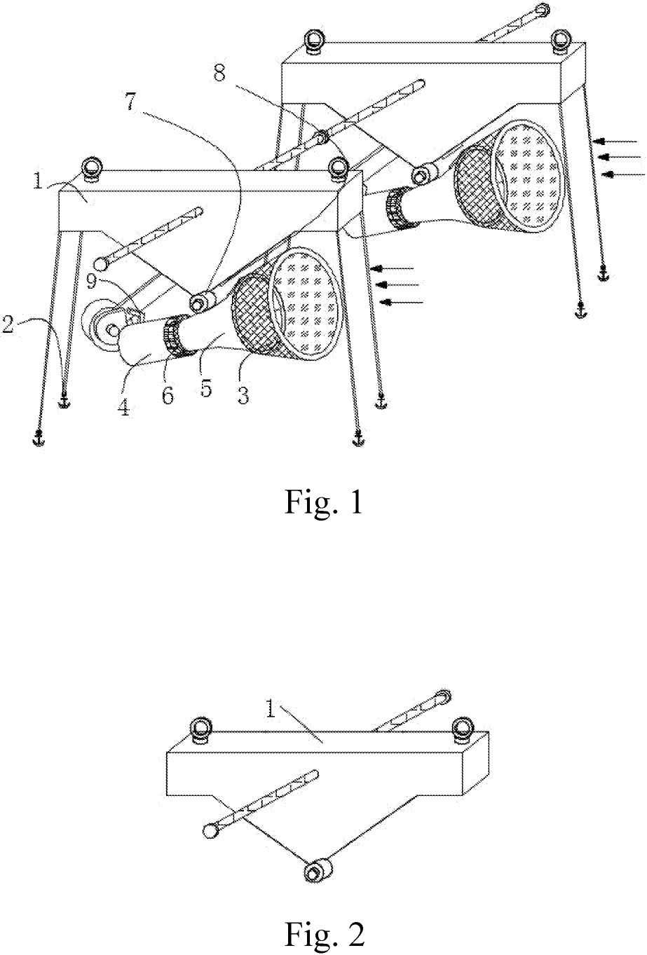

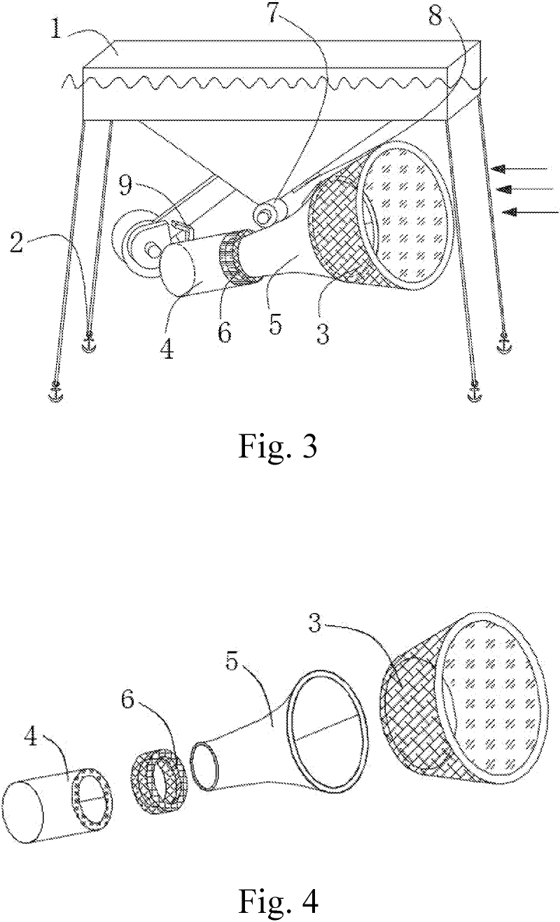

Referring to FIGS. 1-3, a seesaw-type feeding device for collecting suspended solid materials according to a preferred embodiment of the present invention is illustrated. The seesaw-type feeding device, which is configured to collect solid materials suspended in a flow field, comprises a suspension assembly, a material collection assembly located below the suspension assembly, a joint hinge 7 located between the suspension assembly and the material collection assembly, two anti-collision blocks 8 and an escapement shaking assembly 9.

The suspension assembly comprises a V-shaped floating body 1 which floats in an upper interface of the flow field, and at least three fixed bottom anchors 2 which are set on the V-shaped floating body 1. According to the preferred embodiment, the V-shaped floating body 1 is configured to provide buoyancy corresponding to the maximum load of the material collection assembly, in which more than one times the buoyancy richness is allowed, so as to realize the suspension of the material collection assembly in the flow field.

A tip of the V-shaped floating body 1 is set in a lower interface of the flow field, which provides a space for the material collection assembly to shake up and down. Moreover, in order to adapt to the collection of suspended solid materials in a large area flow field, the arrangement, that multiple feeding devices are set in parallel for simultaneous material collection, is described according to the preferred embodiment provided by the present invention. According to the preferred embodiment of the present invention, the connection assembly which comprises ropes and magnets is taken as an example, in which the ropes are fixed on the V-shaped floating body 1, the magnets are installed at an end portion of the ropes with the back toward the V-shaped floating body 1 respectively, and are fixed by the magnetic effect between adjacent magnets, so that the multiple feeding devices are set in parallel. It should be noted that the above connection assembly is configured to connect the multiple feeding devices which are set in parallel. In addition, the connection points are applied to the V-shaped floating body 1 which is configured to provide the buoyancy, the material collection assemblies of the multiple feeding devices shake relatively to the fluid in the flow field under an action of the fluid, so that when the multiple feeding devices are set in parallel, the multiple feeding devices independently shake instead of simultaneous shaking, which are not affected by the connection assembly. Furthermore, in order to facilitate the taking of the feeding device, the V-shaped floating body 1 is also equipped with a lifting buckle to provide a force point. In actual operation, the lifting buckle is connected with the lifting rope to achieve lifting with the external crane. According to the preferred embodiment, the V-shaped floating body and the fixed bottom anchors 2 form the suspension assembly to build a suspension system in tension, so that the material collection assembly is located below the V-shaped floating body 1 and is connected with the V-shaped floating body 1 through the joint hinge 7. It should be noted that the buoyancy provided by the suspension system should not be less than twice the weight of the overall feeding device. There is a tension mooring anchor chain between each of the fixed bottom anchors 2 and the V-shaped floating body 1. In this preferred embodiment, four fixed bottom anchors 2 are taken as an example, the four fixed bottom anchors 2 are evenly distributed at a periphery of the material collection assembly. In other embodiments, according to an actual flow rate of the flow field, the number of the fixed bottom anchors 2 is able to be appropriately added, so that the suspension assembly is able to provide the buoyancy suitable for the current flow field.

The material collection assembly comprises a collection pocket net 3, a material container 4 located at one side of the collection pocket net 3, a delivery part 5 located between the collection pocket net 3 and the material container 4, and an annular water discharging screen mesh 6 located between the delivery part 5 and the material container 4. The collection pocket net 3, the delivery part 5, the annular water discharging screen mesh 6 and the material container 4 are connected in sequence along a direction of the flow field, so that the trumpet-shaped material collection assembly is formed for collecting the suspended solid materials in the flow field.

An inner surface of the delivery part 5 having a conical structure is smooth and curved, a first end of the delivery part 5 is connected with a tail pocket end of the collection pocket net 3, a diameter of a cross section of the first end of the delivery part 5 is larger than that of a second end of the delivery part 5. An outlet end of the annular water discharging screen mesh 6 is fixed at an opening of the material container 4, and a second end of the delivery part 5 is connected with an inlet end of the annular water discharging screen mesh 6. The fluid containing the solid materials freely flows through the second end of the delivery part 5 and the annular water discharging screen mesh 6 in sequence, so that the fluid without the solid materials are filtered out by the annular water discharging screen mesh 6, the solid materials are trapped and enter the material container 4, thereby achieving the purpose of collecting the suspended solid materials in the flow field.

In order to ensure the collection effect of suspended solid materials in the flow field when the feeding device is working, the material container 4 is able to be connected with an automatic processing device of suspended solid materials, so as to achieve the effect of continuous automatic processing of suspended solid materials, such as pumping and conveying processing. The material collection assembly is a combination which is able to be flexibly disassembled. The specific operation is as follows. The collection pocket net 3 is removed, which means that the delivery part 5 is able to be separated from the collection pocket net 3; the annular water discharging screen mesh 6 is removed, which means that the material container 4 is able to be separated from the delivery part 5. It should be noted that the first end of the delivery part 5 is fixed with the tail pocket end of the collection pocket net 3 through bolts (not shown in the drawings), and similarly, the second end of the delivery part 5 is fixed with the inlet end of the annular water discharging screen mesh 6 through bolts (also not shown in the drawings).

The joint hinge 7 is fixed at the tip of the V-shaped floating body 1. The material collection assembly is connected with the joint hinge 7 and is able to freely rotate in a seesaw manner. The delivery part 5 of the material collection assembly is connected with the tip of the V-shaped floating body 1 through the joint hinge 7, so as to achieve the assembly between the material collection assembly and the suspension assembly, thus the whole feeding device has a seesaw-type structure.

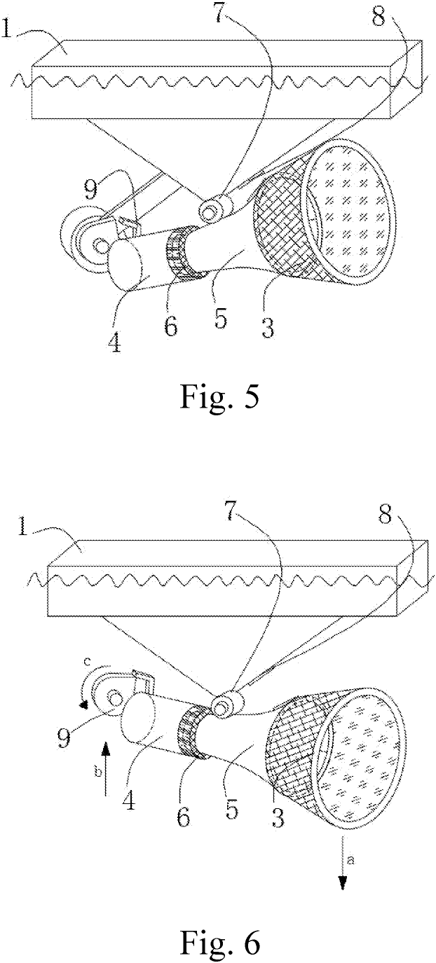

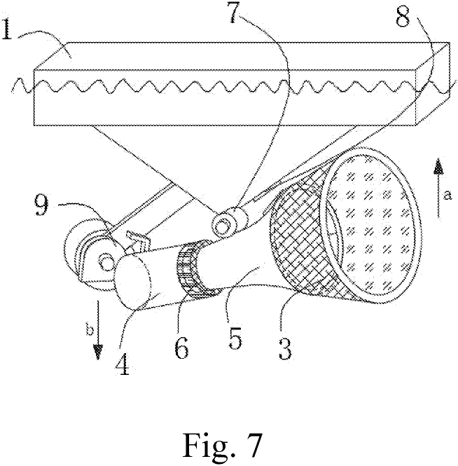

The escapement shaking assembly 9 is fixed on the V-shaped floating body 1 and faces the material collection assembly. The material collection assembly is able to shake relatively the fluid in the flow field, and the escapement shaking assembly 9 drives the material collection assembly to shake. FIG. 5 shows the feeding device in the first state. In the first state, the escapement shaking assembly 9 does not work, the material collection assembly naturally upwardly inclines from the material container 4 to the collection pocket net 3. FIG. 6 shows the feeding device in the second state, in which the arrow a shows the moving direction of one end of the material collection assembly, that is, shows the collection pocket net 3 of the material collection assembly moves downwards; the arrow b shows the moving direction of another end of the material collection assembly, that is, shows the material container 4 of the material collection assembly moves upwards; the arrow c shows the rotating direction of the escapement shaking assembly 9. In the second state, the escapement shaking assembly 9 works. Take the escapement shaking assembly 9 which comprises a cam and a plectrum as an example, the plectrum is fixed on the material container 4, the cam is installed on the V-shaped floating body 1 under the action of the support piece, the drive shaft drives the cam to rotate along the direction indicated by the arrow c; when the cam rotates to contact with the plectrum and further rotates, an upward thrust is applied to the plectrum for driving the another end of the material collection assembly to move upwards, so that the material collection assembly inclines downwards to a predetermined position from the material container 4 to the collection pocket net 3, which is equivalent to a “catching” action. FIG. 7 shows the feeding device in the third state, in which the arrow a shows the moving direction of one end of the material collection assembly, that is, shows the collection pocket net 3 of the material collection assembly moves upwards; the arrow b shows the moving direction of another end of the material collection assembly, that is, shows the material container 4 of the material collection assembly moves downwards. In the third state, when the cam of the escapement shaking assembly 9 rotates to be separated from the plectrum, the upward thrust disappears, so that the “catching” action is stopped, and at this time, the material collection assembly is restored to the natural upward inclined state under the action of dead weight, which is equivalent to a “release” action. The first, second and third states repeat in sequence, so that the material collection assembly cyclically shakes.

According to the preferred embodiment, the escapement shaking assembly 9 applies an operating force with a certain frequency to the material collection assembly, so as to drive the material collection assembly to shake up and down. The specific process is as follows. The escapement shaking assembly 9 works for driving the natural upward inclined material collection assembly to slowly move to the downward inclined state. The escapement shaking assembly 9 stops when the material collection assembly moves to the predetermined position, the escapement shaking assembly 9 stops, the material collection assembly is released and restored to the natural upward inclination state under the action of dead weight, namely, a seesaw-type shaking is completed. The above actions are repeated, so as to shake the material collection assembly up and down at the predetermined frequency, for driving the collection pocket net 3 to shake, thus the materials adhering to the net body of the collection pocket net 3 are constantly falling off. After entering the collection pocket net 3, if the materials float up, then they will be intercepted and adhered to an upper part of the collection pocket net 3; if the materials sink, they will be intercepted and adhered to a lower part of the collection pocket net 3. During the above-mentioned shaking process, either the materials floating up and adhering to the upper part of the collection pocket net 3 or the materials sinking and adhering to the lower part of the collection pocket net 3 are able to continuously fall off from the net body of the collection pocket net 3 under the action of shaking. Further, the solid materials, falling off from the net body of the collection pocket net 3 due to shaking, enter the delivery part 5 under the action of flow field to be collected by the material container 4.

It should be noted that when the escapement shaking assembly 9 drives the material collection assembly to shake, a shaking frequency of both ends of the material collection assembly is not higher than 2 Hz, and an angle between the material collection assembly and the horizontal direction is not less than 10° during the shaking process.

The two anti-collision blocks 8 are configured to adjust a relative position between the material collection assembly and the suspension assembly. One of the two anti-collision blocks 8 is fixed at a position of the V-shaped floating body 1 facing the delivery part 5, and another of the anti-collision blocks 8 is fixed at a position of the delivery part 5 facing the V-shaped floating body 1. The two anti-collision blocks 8, which act as an isolation barrier, ensure that the V-shaped floating body 1 is not in contact with the delivery part 5, so as to avoid collision when the delivery part 5 shakes up and down.

In summary, compared with the collection and processing of traditional pocket nets, the feeding device provided by the present invention has some advantages as follows. The feeding device has a seesaw-type structure. Through the shaking of the material collection assembly, the solid materials are able to continuously fall off from the net body of the collection pocket net 3. Under the action of the flow field, the solid materials gradually automatically gather to the collection area, so that the suspended solid materials in the flow field are not adhered to the net body of the collection pocket net 3, thus the defects of adhesion and fouling during solid material collection in the flow field are overcome. In practical application, the suspended solid materials in the flow field are able to be collected and processed smoothly, and the collection effect is remarkable, which reduces the cleaning and maintenance frequency of the net body, reduces the maintenance cost, improves the work efficiency, so that the promotion prospect is excellent.

The above are basic principles, main features and advantages of the present invention. It should be understood by those skilled in the art that the present invention is not limited by the above embodiment and that the above embodiment only illustrate the principle of the present invention. Without departing from the spirit and scope of the present invention, the present invention is subject to various changes and improvements, which fall within the protection scope of the present invention. The protection scope of the present invention is defined by the attached claims and their equivalents.

What is claimed is:

1. A seesaw-type feeding device for collecting solid materials suspended in a flow field, the feeding device comprising:
a suspension assembly, which comprises a V-shaped floating body floating in an upper interface of the flow field, and at least three fixed bottom anchors which are set on the V-shaped floating body, wherein a tip of the V-shaped floating body is set in a lower interface of the flow field;
a material collection assembly located below the suspension assembly, which comprises a collection pocket net, a material container located at one side of the collection pocket net, a delivery part located between the collection pocket net and the material container, and an annular water discharging screen mesh located between the delivery part and the material container;
a joint hinge located between the suspension assembly and material collection assembly; and
an escapement shaking assembly which is located behind the V-shaped floating body and faces the material collection assembly, wherein:
the material collection assembly is able to shake relatively to fluid in the flow field, and the escapement shaking assembly drives the material collection assembly to shake;
the escapement shaking assembly comprises a cam and a plectrum, wherein the plectrum is fixed on the material container, the cam is installed on the V-shaped floating body under an action of a support piece, and a drive shaft drives the cam to rotate.

2. The seesaw-type feeding device according to claim 1, wherein a tension mooring anchor chain is fixedly connected between each of the fixed bottom anchors and the V-shaped floating body, and a connection assembly is fixed on the V-shaped floating body.

3. The seesaw-type feeding device according to claim 1, wherein an inner surface of the delivery part having a conical structure is smooth and curved, a first end of the delivery part is connected with a tail pocket end of the collection pocket net, and a diameter of a cross section of the first end of the delivery part is larger than that of a second end of the delivery part.

4. The seesaw-type feeding device according to claim 1, wherein an outlet end of the annular water discharging screen mesh is fixed at an opening of the material container, and the second end of the delivery part is connected with an inlet end of the annular water discharging screen mesh.

5. The seesaw-type feeding device according to claim 1, wherein the joint hinge is fixed at the tip of the V-shaped floating body, and the material collection assembly is connected with the joint hinge and is able to freely rotate in a seesaw manner.

6. The seesaw-type feeding device according to claim 1, further comprising two anti-collision blocks for adjusting a relative position between the material collection assembly and the suspension assembly.

7. The seesaw-type feeding device according to claim 6, wherein one of the two anti-collision blocks is fixed at a position of the V-shaped floating body facing the delivery part, and another of the anti-collision blocks is fixed at a position of the delivery part facing the V-shaped floating body.

8. The seesaw-type feeding device according to claim 1, wherein the material collection assembly has three states:
in a first state, the escapement shaking assembly does not work, the material collection assembly naturally upwardly inclines from the material container to the collection pocket net;
in a second state, the escapement shaking assembly works, the material collection assembly inclines downwards to a predetermined position from the material container to the collection pocket net;
in a third state, the escapement shaking assembly stops working, the material collection assembly is restored to a natural upward inclined state under an action of dead weight.
